(19) United States
(12) Patent Application Publication
(10) Pub. No.: US 2002/0051736 A1
(43) Pub. Date: May 2, 2002

(54) Method and device for the automatic preparation of samples

(76) Inventor: Andreas Zucker, Munchen (DE)

Correspondence Address: Stephen M. Evans, GRAYBEAL JACKSON HALEY LLP, 155 - 108th Avenue N.E., Suite. 350, Bellevue, WA, 98004-5901, US

(21) Appl. No.: 10/012,124

(22) Filed: Dec. 4, 2001

Related U.S. Application Data
(63) Continuation-in-part of application No. PCT/EP00/05035, filed on Jun. 2, 2000.

(30) Foreign Application Priority Data
Jun. 4, 1999 (DE) 199 25 658.6

(51) Int. Cl. G01N 1/00

(52) U.S. Cl. 422/99; 422/100; 436/174; 436/180

(57) ABSTRACT

The invention relates to a method and device for the automatic preparation of samples for analytical analysis in a sample tube, wherein the sample to be analyzed and the materials required for the preparation are added to the sample tube through dispensing devices, and the sample tubes and dispensing devices are displaced at least once in relation to each other before the complete addition of the sample and the materials. The device comprises an upper level that includes dispensing devices and a lower level that includes sample tubes. The lower level is displaced relative to the upper level to displace the sample tubes relative to the dispending devices.

### TECHNICAL FIELD

The invention relates to a method and a device for the automatic preparation of samples for analytical analysis and the use of the device for developing sample preparation and/or analysis methods for individual analytes.

### BACKGROUND

The quantitative determination of analytes plays a substantial role in many fields of technology. Examples include the analysis of foodstuffs to check for contamination and hazardous materials as well as the observance of legal standards; the analysis of water, for example, with regard to heavy metal content; the analysis of drugs, for example, with regard to the change of active ingredient content during storage; and the analysis of body fluids for medical diagnosis. The quantitative determination of analytes in such cases is carried out by means of various analytical methods, for example, by chromatographic methods such as high pressure liquid chromatography (HPLC) or gas chromatography (GC), mass spectroscopy (MS), gas chromatography coupled with mass spectroscopy (GC-MS), photometry or atomic emission spectroscopy.

However, before the actual quantitative determination, the sample which contains the analytes must often be prepared in order to remove components disturbing to the determination or in order to release the analytes. For this purpose, the sample may, for example, be brought into contact with various washing solutions in order to remove products soluble in the washing solutions. Solid phase extraction is a further example for sample preparation, wherein the sample to be analysed is absorbed onto a solid phase, the components of the sample which are disturbing for determination of the content are rinsed out, and then the sample is desorbed from the solid phase. These various washing and elution stages can be implemented manually, which naturally requires a considerable expenditure of time.

To allow simpler implementation of sample preparation, an automatic sample-preparation device manufactured by the company Gilson is also known. With this device, the sample is cleaned using a sample tube. This sample tube has an opening at the top and bottom and is generally made from a plastic material. Depending on the analytes, it may be empty, or it may contain a frit or a filter plug or preferably an adsorbent material (e.g. silica gel or aluminium oxide) held between two frits. A large number of these sample tubes are arranged in a storage vessel in eighteen rows with six sample tubes alongside each other in each row. An automatic supply device with six syringes located directly above one of the rows of sample tubes is located above this storage vessel. At the end of each syringe is a valve from which lines lead to storage vessels. During the sample preparation, the column is firstly conditioned, for example, with an organic solvent and then with an inorganic solvent, whereby the addition is implemented from a storage container via the syringe allocated to each sample tube.

Following this, the sample containing the analytes, for example, a human urine or blood sample, is added to each of the six sample tubes via the allocated syringe. Normally, in the case of urine or blood samples, an adsorbent onto which the analyte is absorbed is contained in the sample tubes. By adding one or more washing solutions, again from the various storage vessels via the syringes allocated to the individual sample tubes, the materials not to be analysed can be rinsed out. Because the sample tubes are open at the bottom, the various washing solutions can be eluted from the tube either by applying a slight pressure from above and rinsing with air (through the relevant syringe) or by applying a vacuum from below. In the last stage of the method, an elution solution, with which the analyte is rinsed from the adsorbent, is again added via the automatic supply device, whereby the elution solution containing the analyte is collected at the bottom end of the sample tube. All materials added (liquids and gases) and the sample in the sample tube, are therefore supplied via an individual syringe. After complete processing of the first row of sample tubes, the automatic supply device moves with the six needles to the next row of sample tubes and again runs through the various stages of the method. This procedure is repeated until all rows of the storage vessel have been processed Then, the storage vessel is removed from the apparatus, the used sample tubes are rejected and the collected elution solutions with the relevant analytes are conveyed to an analysis device, for example, an auto sampler of an HPLC apparatus, where they are analysed.

A similar device manufactured by the company Hamilton is also known. In the case of one special embodiment of the Hamilton device, the addition of the various solutions and the sample is not implemented via a single needle, but via a bundle of needles, whereby each individual needle in the bundle is connected via a connecting line to an allocated storage container. When the sample and all necessary materials have been added, the needle bundle or a group of several needle bundles moves to the next sample tube or to the next row of sample tubes, until, in a similar manner to the Gilson device, all of the sample tubes in the storage vessel have been processed. The prepared samples eluted from the sample tubes are then again transferred to an analysis device.

However, these known devices manufactured by Gilson and Hamilton have the disadvantage that the accuracy of the analysis is not optimum. Because the individual sample tubes are processed one after the other, the residence time of the ready-treated samples which have been prepared for analysis until the actual implementation of the analysis is different for the individual samples in the multitude of sample tubes in a storage vessel. Since the prepared samples frequently contain volatile organic solvents, a portion of this solvent evaporates before the individual sample is analysed, with the result that the concentration of the analytes in the prepared sample changes. Since the residence times until analysis are different for individual samples, the loss of solvent and change in concentration is also different. In order to counter this problem, an internal standard is added, which, however, necessarily introduces an uncertainty factor into the quantitative determination and makes the method more complicated. The internal standard should resemble the analytes in its chemical and physical properties as much as possible. However, it is generally difficult to find an internal standard with similar properties to a given analyte. A second problem of the known method, which can also not be resolved by means of an internal standard, is present if the analyte itself is volatile. In this case, the sample tube must either be sealed or cooled, thereby making the whole method significantly more complex.

The object of the present invention is therefore to provide a method and a device for the implementation of this method that allows more accurate analysis.

### SUMMARY OF THE INVENTION

The present invention provides a device and a method for quickly preparing more than one sample of analytes that are consistent or substantially consistent with each other. The device comprises an upper level and a lower level that can be displaced relative to the upper level or vice-versa. The lower level includes several retaining devices for retaining sample tubes, and the upper level includes at least two, preferably three to eight dispensing devices that convey sample material and/or one or more materials or reagents to the sample tubes. By having each dispensing device convey the same material and/or reagent to a sample tube as the sample tube moves relative to the dispensing device or vice-versa, the device prepares an analyte in sequential stages that results in the analyte being isolated or developed just before analysis. Thus, the analyte being analysed is consistent or substantially consistent with previously and subsequently analysed analytes, producing more accurate results.

In another aspect of the invention, the dispensing device forms a seal with the sample tube before the dispensing device conveys the sample material and/or reagents to the sample tube to reduce contamination from outside the dispensing device and sample tube from entering the sample tube. When the sample tube is located under a dispensing device, the dispensing device moves toward the sample tube and can form a seal with the tube while the dispensing device conveys sample material and/or reagents to the sample tubes. This also has the advantage of minimizing evaporative losses of currently or previously conveyed reagents or materials.

In another aspect of the invention, a method is provided for automatically preparing consistent or substantially consistent analytes that provide more accurate results during analysis. In one embodiment, the method comprises automatically supplying a sample material and/or one or more materials or reagents to a sample tube in a predetermined sequence via at least two dispensing devices at respective operating stations. The predetermined sequence comprises conveying sample material to a first sample tube located at a first operating station via an initial dispensing device. Then, moving the first sample tube to a subsequent operating station where the first sample tube is located opposite a subsequent dispensing device and moving a second sample tube to the first operating station. Then, conveying one or more reagents or other materials through the second dispensing device to the first sample tube, and conveying sample material to the second sample tube via the first dispensing device. This sequence of moving the first, second and other tubes to first, second and subsequent operating stations can continue for any desired number of stations as long as the sample and/or all of one or more other materials or reagents are not added at one operating station. Consequently, the anayte to be analysed is not completely prepared until it has passed through the last station and is then ready to be analysed. This, eliminates the need for a cumbersome internal standard.

Another advantage of this method is that one can easily, and in real time, adjust the chemical or physical process of isolating or preparing an analyte based on the test results of a previously isolated or generated analyte. One does not have to throw out a whole batch of incorrect or poor analyte.

### BRIEF DESCRIPTION OF THE DRAWINGS

FIG. 1 is a plan view of a device according to an embodiment of the invention;

FIG. 2 is a lateral view of the device in FIG. 1 according to an embodiment of the invention; and

FIG. 3 is a sectional view of a single dispensing device with corresponding sample tube according t an embodiment of the invention.

### DETAILED DESCRIPTION

This object is achieved with a method for automatic preparation of samples for analytical analysis, in which a sample to be analysed and one or more materials necessary for the preparation are added by automatic supply devices from storage vessels via connecting lines and at least two dispensing devices to a sample tube in a predetermined sequence, characterised in that after the addition of a sample and/or one or more of the materials through the first dispensing device, sample tubes and dispensing devices are displaced in relation to each other once, or optionally several times, so that the further addition or the further additions of the sample and/or one or more of the materials is or are implemented through the second and optionally further outlet device(s), i.e. the sample and/or one or more of the materials, but not all materials and the sample, are added via each of the dispensing devices.

With the method according to the present invention, unlike the currently known methods, the individual stages of sample preparation are not implemented successively for each individual sample tube with one needle or with a needle bundle before the next sample tube is treated, but the individual stages of sample preparation are implemented successively for each sample tube at the various dispensing devices, i.e. sample tubes and dispensing devices are displaced at least once in relation to each other before the complete addition of samples and all materials necessary for the preparation.

For example, a first sample tube receives a conditioning solution from a first dispensing device. (It is preferable to use the sample tubes described above with an opening at the top and the bottom end as sample tubes. The analyte or material(s) for sample preparation are added from the top and removed at the bottom opening by applying positive pressure from above or negative pressure from below or by rinsing with an elution solution. However, tubes with only one upper opening can also be used, whereby the added samples and materials are removed after contact with an adsorbent and/or other materials through the upper opening, for example, by suction.) The first sample tube is then displaced to a second dispensing device (or vice versa), where, for example, the sample to be analysed is introduced. Preferably, at the same time, a second sample tube is transported to the first dispensing device and there, in its turn, receives the conditioning solution. Then the first sample tube is conducted to a third device and a washing solution is added there, while the second sample tube receives a sample at the second dispensing device in its turn, and a third sample tube is conditioned at the first dispensing device. Following this, the sample tube is again displaced to the next dispensing device, whereby, for example, the analyte to be analysed from the first sample tube is desorbed from the sample tube through the addition of an elution solution at the fourth dispensing device, and the desorbed sample is transported to an analysis device, while the second sample tube is located at the third dispensing device, the third sample tube at the second dispensing device and a newly introduced, fourth sample tube at the first dispensing device. In the next stage, the sample tubes are again displaced by one step, so that the first sample tube, for example, can be removed, while the analyte from the second sample tube is desorbed, and a fifth sample tube is introduced at the start of the chain. Preferably, the sample tubes and dispensing devices are each displaced in relation to each other by a predetermined distance, whereby the distance between the sample tubes and the distance between the dispensing devices in each case is the same as or a multiple of this distance. After every stage of addition, the solution released at the lower end of the sample tube is preferably trapped and collected (optionally for recycling) or rejected, while the solution containing the analyte is conducted on, preferably automatically, for analysis.

At the individual supply stations, samples and/or one or more solutions and/or gases may be added. For example, it is advisable after adding the sample to rinse the dispensing device with a rinsing solution, to avoid sample contamination of the sample added to the next sample tube due to lack of rinsing. Moreover, it is often advantageous, after adding e.g. a washing solution or the sample solution, to conduct a gas (for example air) through the dispensing device into the sample tube, in order to ensure through the pressure exerted that the solution passes through the sample tube, which normally provides an opening at the lower end where it can be trapped. This is particularly advisable if small quantities of solvent are added and/or if an adsorbent is present in the sample tube. Instead of rinsing with gas, a vacuum can also be applied to the lower end of the sample tube.

In the case of the method according to the invention, the slowest addition stage determines the duration of the individual addition stages. The duration of the individual additions, the number of individual additions and therefore also the total residence time are therefore identical for every individual sample, so that each prepared sample solution arrives at the analysis device after an identical residence time. The different losses of solvent found in the prior art as a result of differing residence times do not therefore occur so that the addition of an internal standard can be dispensed with, thereby simplifying the overall method and increasing measuring accuracy.

Alongside this advantage, the method according to the invention also offers other advantages. For example, in the case of the known devices, all rinsing solutions with the exception of the elution solution containing the analyte are trapped in a collecting dish situated beneath the sample tube. Since some of the solutions contain organic solvents or also human body fluids such as e.g. blood or urine, the entire solution must be disposed of as special waste. However, in the case of the method according to the invention, the individual rinsing solutions are trapped separately in each case at the individual supply stations beneath the individual sample tubes, so that organic solvents, human body fluids and other solutions are separated. The quantity of special waste is thereby considerably reduced, and some of the solutions can optionally also be recycled after cleaning stages.

Another advantage is that with the method according to the invention, unsupervised operation of the device is no longer required. For example, it is conventional with the known devices for sample preparation to be implemented automatically overnight, so that the prepared samples can then be analysed during the day. However, one problem in this context is that if there are any malfunctions, the automatic sample preparation will be interrupted, with the result that only some of the samples are actually prepared for analysis, which leads to a considerable loss of time. In the case of the method according to the invention, this unsupervised operation is no longer necessary, because ready-prepared analysis solutions can be produced continuously, by working in a stepwise manner through the individual sample tubes, which can then be analysed directly.

Finally, the method according to the invention also allows actual online analysis, because the solution containing the analytes can be transported directly to an analysis device and analysed there immediately, whereas with the known devices, the samples must first be removed from the sample-preparation device and then taken manually to the analysis device.

Furthermore, one major advantage of the method according to the invention is that it is also suitable for the development of sample-preparation or sample-analysis methods for individual analytes. A frequent problem is to find for a given analyte the fastest possible and most reliable analysis method including sample preparation. This must be determined through extensive experiments. With the method according to the invention (and device according to the invention), this development can be simplified, because for a given analyte, the sample-preparation method can be implemented repeatedly and the solutions added and their quantities can be altered via a computer program. The result can be read off directly from a connected analysis device and the best combination can be determined.

The device for implementing the method according to the invention contains at least two dispensing devices, through which a sample to be analysed and one or more materials required for preparation can be dispensed in a predetermined sequence, and one or more devices for retaining sample tubes, wherein the at least two dispensing devices are arranged spatially separated from each other in the device, i.e. they have a distance from each other such that the addition of the sample and all materials to a sample tube, which may optionally be located in a device for retaining sample tubes, is possible merely by a displacement of the sample tube (or of the device for retaining sample tubes which contains the sample tube) and the dispensing devices in relation to each other.

The device preferably contains automatic supply devices with, among other things, storage vessels and connecting lines. The automatic supply devices generally also provide a conventional pump that is connected on one side via a conventional connecting line (e.g. made from plastic material) to a dispensing device, and on the other side again via a connecting line to a storage vessel in which a solution required for the preparation of the samples is contained. The pump used may also be connected to a device, which in known manner successively removes various pre-positioned samples. Moreover, the pump is controlled, also in known manner, via a computer system so that the timing of additions and the volume of the solutions, gases or samples added are predetermined.

The dispensing devices are, for example, syringes or cannulas made from metal or plastic which are fitted into the device according to the invention and connected via connecting lines to pumps and storage containers. Accordingly, a single dispensing device may consist of several, for example three, individual needles or hoses, each of which is connected separately via connecting lines and a pump to the storage container allocated in each case. Preferably, however, the individual dispensing devices terminate in a single needle and preferably provide two or three separate accesses. This means that different materials can be supplied from several storage vessels via individual pumps and lines through the single inlet of an individual dispensing device and introduced into the needle. This may be advantageous, for example, when adding the individual sample solutions, because, initially, the sample solutions can be supplied via the first inlet, and then a washing solution from a second storage vessel with a separate pump and separate connecting line can be introduced via the second inlet into the needle. Then air can be used for subsequent rinsing via the third inlet. If necessary, the individual dispensing devices may also comprise more than three inlets.

Furthermore, the dispensing device preferably comprises a gasket fitted with a spring, which fits exactly over the upper opening of the sample tube. When the sample tubes are displaced towards the individual dispensing devices, or vice versa, the dispensing devices can be fitted onto the sample tubes to form a tight seal. (Alternatively, the sample tubes can be pressed against the dispensing devices.) Firstly, this has the advantage that the tube is sealed during the addition, so that no contamination can enter from outside, and the loss of solvent is kept to a minimum Moreover, this closure is advantageous when rinsing through with air (or nitrogen or another gas), because in this case the gas can only escape through the lower opening of the sample tube.

Preferably, the device according to the invention comprises a lower and an upper level, and on the upper level of the device, there are the at least two, preferably three to eight dispensing devices, while on the lower level, there are several devices for retaining sample tubes in the form of recesses or sample tubes inserted into the recesses. The dispensing devices and the recesses/sample tubes are arranged such that in each case the dispensing devices are directly above a recess/sample tube, that the distance between two dispensing devices corresponds to the distance between two recesses/sample tubes, or a multiple thereof, and that the lower and the upper levels can be displaced in relation to each other. In this context, the lower level is preferably a turntable and the upper level is preferably a circular disc, however, other, for example belt-shaped (linear), embodiments are also possible. The upper and lower levels are normally connected to each other by means of a rod.

When operating the device, the relevant solvent or the relevant gas is first conveyed from the various dispensing devices into the allocated sample tube. After this addition has been completed, the upper level, for example, is raised via the rod connecting it to the lower level and via a known motor drive (electrically or pneumatically driven) which is controlled by a computer program adjusted for the addition of the various solutions and gases. In this context, the upper level must be raised so far that the dispensing devices no longer project into the sample tubes. Following this, the lower level is rotated while the upper level remains unchanged, so that each sample tube is transported to the adjacent dispensing device (if present). The rotation of the lower level is preferably implemented by means of a stepper motor (driven electrically or pneumatically), which, like the motor for lifting the upper level, is controlled via a computer program depending on the addition of solutions and gases. After the rotation has been completed, the upper level is lowered again so that the dispensing devices project preferably approximately 2 mm into the sample tubes and preferably seal the sample tubes by means of the gaskets located at their lower ends. The next addition is now implemented, and the rotation method is then repeated, until the sample preparation is complete. Of course, it is also possible to lower the lower level, to rotate the upper level and then to raise the lower level again. In the case of the linear design of the invention, the vertical movement can be carried out pneumatically.

Preferably, the device provides a known mechanism at the front end with which fresh sample tubes are placed into the lower level in front of the first supply station, and furthermore, another known device at the rear end of the lower level, with which the used sample tubes are automatically removed from the lower level after the last supply station and rejected. For the implementation of the insertion and removal of the sample tubes, it is advantageous if the upper level has a cut-out.

Since the device according to the invention can be used for a multitude of different sample preparations with a variable number of addition stages, some of the dispensing devices are not activated for individual applications, i.e., these dispensing devices are, in this case, not connected to pumps etc. or are dismantled, so that no additions are made from these stations.

Moreover, it is preferable that a device is provided at the stage at which the analyte is eluted from the sample tube, in order to conduct the ready-prepared sample directly to an analysis device. For example, a tray or funnel (e.g. made from brass) may be provided for this purpose under the sample tube, which leads via a hose or a fixed line linked directly to the analysis device. In this manner, in the last stage of the preparation, with a given elution volume which is applied to the sample tube, and subsequent rinsing with air, the entire predetermined elution volume can be supplied via the tray or funnel and line to the injector of the analysis unit. If the analysis method lasts longer than the entire sample preparation, the prepared samples may also be supplied to two or more analysis devices. For example, a first prepared sample is analysed by a first analysis device, a second prepared sample is analysed by a second analysis device, a third prepared sample is again analysed by the first analysis device, a fourth prepared sample is again analysed by the second analysis device etc.

The analysis unit is selected according to the material to be analysed. The following techniques may be considered, for example, HPLC, MS, GC-MS, IR, or NMR, whereby the actual analysis is carried out in known manner in the analysis unit. If the analysis unit is an HPLC unit, for example, the elution solution will be introduced into the injection loop of the HPLC injector. In this context, if the elution volume is selected to be greater than the volume of the injection loop, this will ensure that the injection loop is always filled and that the analysis device always receives the same volume to be analysed.

The method and the device according to the invention can be used for preparing samples of any analytes required, for example, for the analysis of vitamins, medicines, drugs or for environmental analysis. Depending on the analyte, the type and quantity of materials added will also vary (=solutions, suspensions, dispersions, gases etc.).

One example for the determination of vanillic-mandelic acid from urine is given below:

Reagent 1: Conditioning reagent (glacial acetic acid/water/ethanol (1/1/2 v/v/v))

Reagent 2: Washing reagent 1 (sodium acetate 2M)

Reagent 3: Washing reagent 2 (acetic acid 2N/water/ethanol (1/1/2 v/v/v))

Reagent 4: Elution reagent (0.5 M phosphoric acid)

For preparation of samples of vanillic-mandelic acid from urine, the sample-preparation unit has five operating stations. The analysis is carried out by means of HPLC.

Station 1: Dosage of reagent 1

Station 2: Dosage of patient sample

Station 3: Dosage of reagent 2

Station 4: Dosage of reagent 3

Station 5: Dosage of reagent 4

In the first operating stage, the first sample-preparation column is positioned under station 1. The upper disc moves down and 3 ml of reagent 1 are conveyed to the first column or first sample tube. The disc then moves up again.

In the second operating station, the lower disc rotates one position further. The first column is now under station 2, the second column or second sample tube is under station 1. The upper disc moves down. 0.5 ml of patient urine are now conveyed to the first column. At the same time 3 ml of reagent 1 are conveyed to column 2.

In the third operating station, the disc rotates one position further. The first column now stands under station 3, the second column under station 2 and the third column or third sample tube under station 1. The upper disc moves down. Now, 3 ml of reagent 2 are conveyed to the first column, 0.5 ml of patient urine to the second column, and 3 ml of reagent 1 to the third column.

In the fourth operating station, the disc moves one position further. The first column is now under station 4, the second column under station 3 etc., and 3 ml of reagent 3 are conveyed to the first column, 3 ml of reagent 2 to the second column, 0.5 ml of patient urine to the third column, and 3 ml of reagent 1 to the fourth column or fourth sample tube.

In the fifth operating station, the disc rotates one position further. The first column now stands under station 5, the second column under station 4 etc., and 5 ml of reagent 4 (equal to elution solution) are now conveyed to the first column and fed into the HPLC injection system. 3 ml of reagent 3 are conveyed to column 3, 3 ml of reagent 2 to column 4 etc. (Even if it is not mentioned expressly at the individual operating stations, it goes without saying that the disc is lowered after adopting a new position and is displaced upwards at the end of each operating station.)

The preparation of the first sample is thus completed and injected into the HPLC system. At each successive operating station, a further sample has passed through the complete preparation procedure.

The number and type of reagents may vary in different types of analysis. As a result, the number of activated stations in the machine may also vary. With the different reagents, the metered quantities may also naturally be different.

One embodiment of the invention is shown in the drawings and will be described in greater detail below.

The embodiment shown in the drawings of a device for automatic sample preparation comprises a circular disc 10 and a turntable 12 arranged concentrically below it, both of which are arranged horizontally. The circular disc 10 is borne by a vertical rod 30 and can be raised and lowered by a mechanism not shown in detail. The turntable 12 can be rotated around the rod 30 in a stepwise manner by means of a mechanism that is also not shown in detail.

N dispensing devices 14/1 to 14/N are provided in the circular disc 10 at the same radial distance from the centre point and, in each case, at the same angular distance, to which, in each case, three connecting lines 20 (only shown for dispensing device 14/1 in FIG. 2) are connected via three inlets 15.

In the turntable 12 at the same radial distance and at the same angular distance as in the dispensing devices 14, bore holes 18 are provided in which sample tubes 26 are placed, which are open at the top and comprise an adsorbent agent 28 at the bottom. The sample tubes 26 are flush with the dispensing devices 14, and the step width of the rotation of the turntable 12 corresponds to the distance between two dispensing devices 14.

The sample tubes 26 are inserted or removed into the retaining bore holes 18 at an insertion station 16 and at a removal station 17. To allow sufficient space for the insertion and removal of the sample tubes 26 into the retaining bore holes 18, the circular disc 10 is cut away at one position 34.

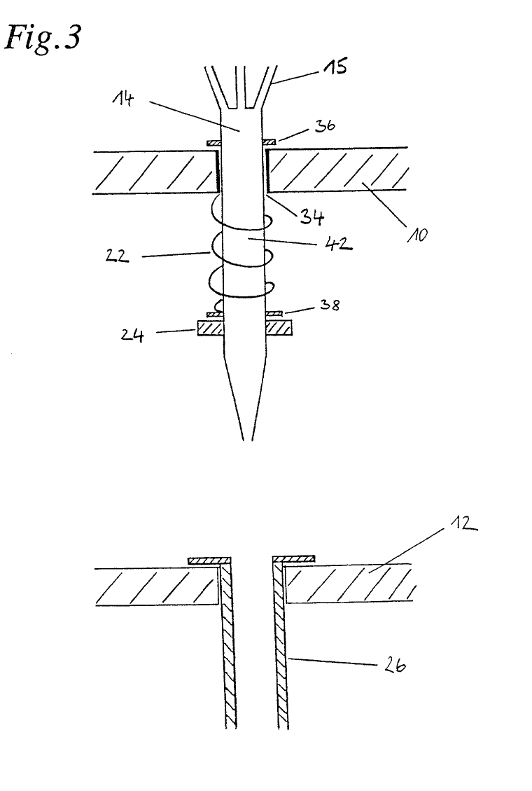

FIG. 3 shows in detail a dispensing device 14 with a sample tube 26 (shown only in part) located beneath it. The dispensing device 14 comprises a needle-shaped element 42, which can be pushed vertically into a bore hole 34 of the circular disc 10 (shown only in part), whereby the two end positions are limited by an upper and a lower annular thickening 36, 38 on the outer side of the needle element 42. The needle element 42 is pressed into its lower end position by a helical compression spring 22 on the needle element 42 between the lower side of the circular disc 10 and the lower thickening 38. Below the lower thickening 38, another disc-shaped sealing element 24 is seated, which lies tightly on the opening edge of the sample tube 26 when the circular disc 10 is lowered.

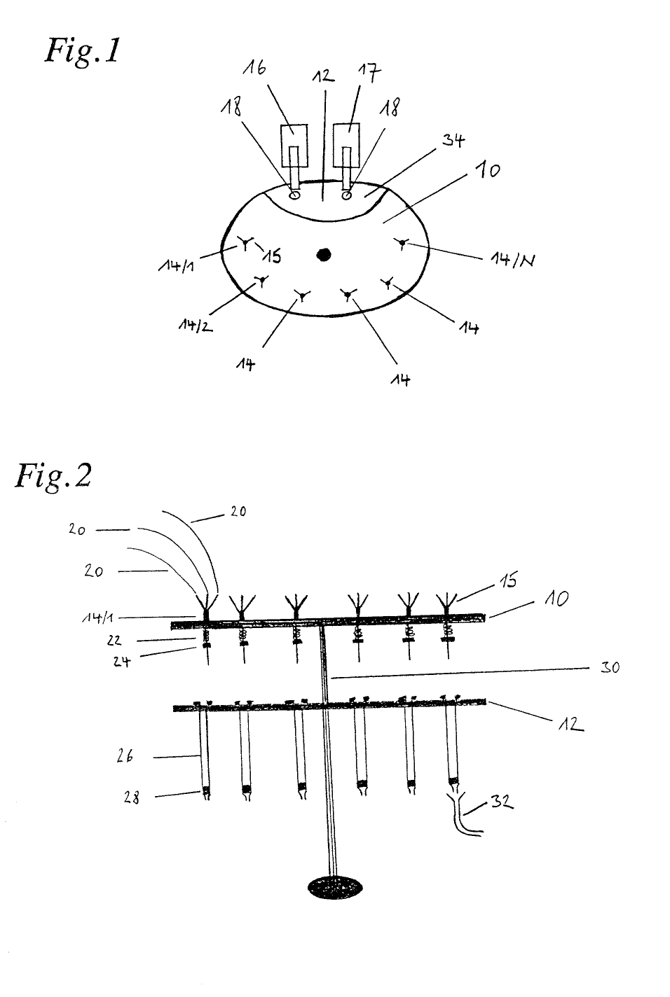

During operation, a sample tube 26 is inserted at the insertion station 16 into the retaining bore holes 18 (FIG. 1). The turntable 12 (only shown in part in FIG. 3) is rotated stepwise in anticlockwise direction at each operating stroke, whereby each sample tube 26, after its insertion into the retaining bore hole 18, arrives through the first operating stroke under the first dispensing device 14/1, and then arrives through each operating stroke under the next dispensing device 14 in each case, until the final dispensing device 14/N. With the final operating stroke, the sample tube 26 is then moved back into the recess 34 of the circular disc 10, where it is removed.

After each rotary step of the turntable 12, the circular disc 10 with the dispensing devices 14 is lowered, so that the sealing element or gaskets 24 are seated on the opening edges of each of the sample tubes 26. In each case, 500 μl of reagent are dispensed into the sample tubes by the first and second dispensing devices 14/1 and 14/2. The blood or urine sample to be analysed is added to the sample tube 26 by means of the third dispensing device 14/3. The other dispensing devices 14/4 to 14/N-1 each supply different rinsing solutions. At the last dispensing device 14/N, an elution agent is supplied with which the sample is eluted. At this position, a funnel 32 (FIG. 2) is positioned under the open end of the sample tube 26, which collects the eluted sample. The sample is conducted to an analysis device via a line. After dispensing the reagents, the sample or the rinsing and elution solutions, the circular disc 10 is then raised again in each case and the turntable 12 is rotated one step further, so that each sample tube 26 arrives under the next dispensing device 14.

What is claimed is:

1. A method for automatically preparing analyte from a sample material for analysis, comprising:
placing a fresh first sample tube into a retaining device on a lower level of an automatic preparation device;
locating the first sample tube at a first operating station where an initial dispensing device is located on an upper level of the automatic preparation device, and placing a fresh second sample tube into another retaining device;
conveying a sample material to the first sample tube via the initial dispensing device;
displacing the first sample tube relative to the dispensing device to a second operating station, locating a second sample tube at the first operating station and placing a fresh third sample tube into another retaining device; and
conveying one or more materials to the first sample tube through a subsequent dispensing device also located on the upper level, conveying a sample material to the second sample tube via the initial dispensing device; and
removing used sample tubes from the lower level.

2. The method of claim 1 wherein conveying a sample material and one or more materials includes moving at least one of the upper and lower levels toward each other and forming a seal between the dispensing device and the sample tube.

3. The method of claim 1 wherein removing used samples includes automatically conducting the prepared analyte in the used sample tubes to an analysis device.

4. A device for automatically preparing an analyte from a sample material for analysis, comprising:
an upper level that includes at least two dispensing devices located a distance from each other through which sample material and one or more materials required for the preparation of the analyte can be dispensed;
a lower level movable relative to the upper level and that includes one or more retaining devices for retaining sample tubes opposite the dispensing devices and at the same or approximately the same distance from each other as the distance between the dispensing devices on the upper level, wherein the sample material and materials are dispensed from respective dispensing devices to the sample tubes in a predetermined sequence by displacing the lower level relative to the upper level; and
a removal device for automatically removing used sample tubes from the lower level.

5. The device of claim 4 wherein the displacement of the lower level relative to the upper level further includes moving at least one of the lower and upper levels vertically toward each other.

6. The device of claim 4, wherein the retaining devices retain the sample tubes a distance from each other that is a multiple of the distance that separates the dispensing devices on the upper level.

7. The device of claim 4 wherein the lower level is a turntable and the upper level is a circular disc.

8. The device of claim 4 further comprising an analysis device for analysing the analyte after the analyte is prepared.

9. The device of claim 4 further comprising a sample tube supply device for supplying fresh sample tubes to the lower level.

10. The device of claim 4 further comprising:
a supply device for conveying at least one of the sample material and one or more materials to the dispensing device and that includes a storage vessel;
connecting lines for connecting the supply device to the dispensing devices;
an analysis device for analysing the analyte after the analyte is prepared;
a conducting device for automatically conducting the analyte from the lower level to the analysis device;
a removal device for automatically removing used sample tubes from the lower level; and
a sample tube supply device for supplying fresh sample tubes to the lower level.
